(19) United States
(12) Patent Application Publication
(10) Pub. No.: US 2008/0074423 A1
(43) Pub. Date: Mar. 27, 2008

(54) Method and System for Displaying Graphical Objects on a Digital Map

(75) Inventors: Zhen-Qi Gan, Carrollton, TX (US); Cesar J. Alaniz, Dallas, TX (US); Darryl P. Nelson, Plano, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 11/534,818

(22) Filed: Sep. 25, 2006

(51) Int. Cl. G06T 15/20

(52) U.S. Cl. 345/427; 345/630

(57) ABSTRACT

According to one embodiment of the invention, a method for displaying graphical objects on a digital map includes receiving, for a graphical object, metadata comprising a parameter indicating a type of the graphical object, a parameter indicating a size of the graphical object, and a group of parameters indicating a geographic location of the object represented by the graphical object. The type of the graphical object is one of a group of stored types. The method further includes rendering the graphical object on the digital map by generating, based the received metadata, a group of geographic coordinates for the graphical object.

### TECHNICAL FIELD OF THE INVENTION

This invention relates generally to digital maps, and more particularly, to a method and system for displaying graphical objects on a digital map.

### BACKGROUND OF THE INVENTION

Digital maps have been developed to search for, identify, and discover information about geographic locations. Some mapping programs generate digital maps using satellite imagery. Examples of such mapping programs include Google Earth and Microsoft's Virtual Earth. Such existing mapping programs typically provide a base digital map along with simple lines to draw simple graphics and annotations to describe map features. These existing mapping programs, however, do not natively support the display of more complicated 2D and 3D graphical objects.

### OVERVIEW OF EXAMPLE EMBODIMENTS

According to one embodiment of the invention, a method for displaying graphical objects on a digital map includes receiving, for a graphical object, metadata comprising a parameter indicating a type of the graphical object, a parameter indicating a size of the graphical object, and a group of parameters indicating a geographic location of the object represented by the graphical object. The type of the graphical object is one of a group of stored types. The method further includes rendering the graphical object on the digital map by generating, based on the received metadata, a group of geographic coordinates for the graphical object.

Technical advantages of particular embodiments of the present invention include a method and system for displaying graphical objects on a digital map that generates markup language code from simple metadata describing the graphical object. Thus, development time and software maintenance costs to render the graphical objects are dramatically reduced.

Another technical advantage of particular embodiments of the present invention includes a method and system for displaying graphical objects on a digital map that automatically retrieves graphical object information through a subscription mechanism. Thus, the present invention dynamically updates the graphical objects in real time.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a system for displaying graphical objects on a digital map according to the teachings of the invention;

FIG. 2 is a representative image illustrating graphical objects on a digital map in accordance with an embodiment of the present invention; and

FIG. 3 is a flow chart illustrating example acts associated with a method for displaying graphical objects on a digital map.

### DESCRIPTION OF EXAMPLE EMBODIMENTS

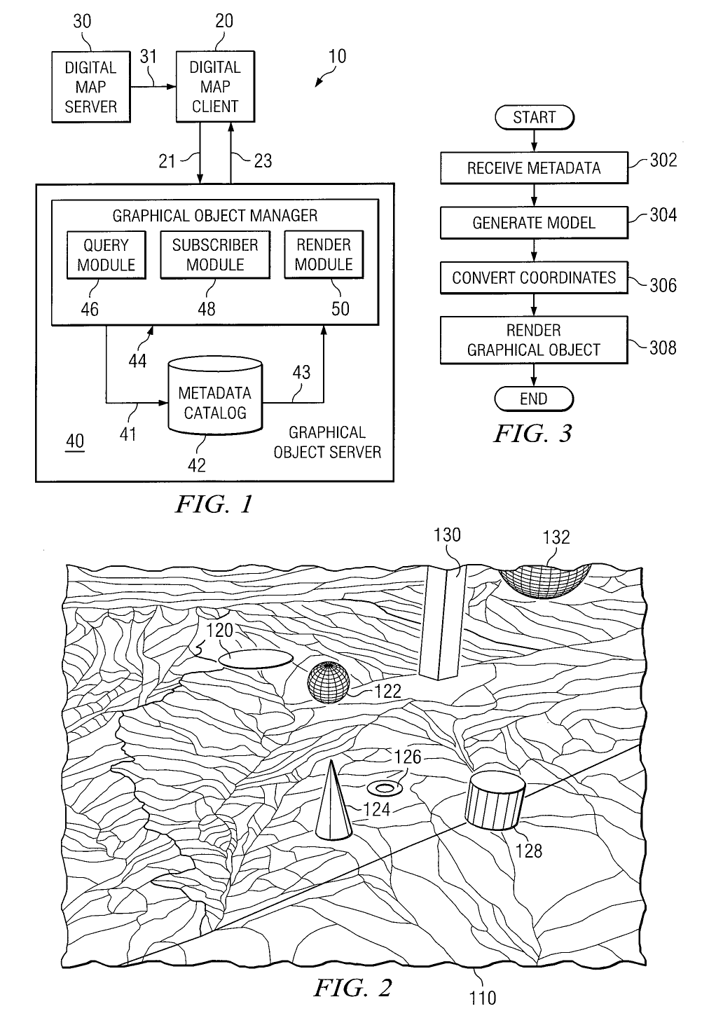

Embodiments of the present invention and its advantages are best understood by referring to FIGS. 1 through 3 of the drawings, like numerals being used for like and corresponding parts of the various drawings.

FIG. 1 is a block diagram illustrating a system 10 for displaying graphical objects on a digital map according to the teachings of the invention. As shown in FIG. 1, system 10 generally includes a digital map client 20, a digital map server 30, and a graphical object server 40. System 10 is particularly adapted for displaying graphical objects on a digital map.

Digital map client 20 may refer to any suitable device operable to display a digital map. A digital map may refer to any computerized representation of a geographic area that can be displayed and analyzed by a computer. For example, the most common method of digital map creation is digitization, where a hardcopy map is transferred into a digital medium through the use of a computer program and geographic information. As another example, a digital map may be generated by converting existing digital information, which may not yet be in map form, into forms a computer can recognize and use. Thus, digital satellite images generated through remote sensing may be combined to produce a map-like layer of digital information, resulting in a flat projection of the earth's surface.

In particular embodiments of the invention, digital map client 20 may be operable to execute an application, such as Google Earth, that allows a user to interact with a digital map. Google Earth is an application that maps the earth by combining images obtained from satellite imagery. By entering the appropriate commands, a user may instruct Google Earth to “zoom” to a lower relative viewing position, such that Google Earth displays a digital map of a smaller geographical area that is shown at a higher degree of resolution. Google Earth also allows the user to “scroll” or “fly” to a different lateral position on the digital map. In other embodiments of the invention, digital map client 20 may be operable to execute other applications, such as Microsoft's Internet Explorer browser, that allows a user to interact with a digital map through the Internet.

Digital map client 20 may execute with any of the well-known MS-DOS, PC-DOS, OS-2, MAC-OS, WINDOWST™, UNIX, or other appropriate operating systems, including future operating systems. Digital map client 20 may include, for example, a personal digital assistant, a computer such as a laptop, a cellular telephone, a mobile handset, or any other device operable to display a digital map.

Digital map server 30 may refer to any suitable device operable to deliver a digital map, images, scripting languages, and other static elements that are sent to digital map client 20, as indicated by reference number 31.

According to a particular embodiment of the invention, digital map server 30 may include software operable to facilitate a tile serving system operable to deliver individual digital map tiles in response to requests from digital map client 20. For example, digital map server 30 may organize mapping data into a hierarchy of successive magnitudes for presentation of the mapping data with variable resolution, starting from a first highest magnitude with lowest resolution and progressing to a last magnitude with highest resolution. Thus, the tile serving system may have fewer tiles at the top, and each successive descending level may contain four times as many tiles as the level directly above it. This software may properly interface with corresponding software provided in digital map client 20. Alternatively, digital map server 30 may include any other suitable software operable to deliver individual map tiles in response to requests from digital map client 20.

Graphical object server 40 represents any suitable device operable to render graphical objects for display on a digital map at digital map client 20. Although FIG. 1 provides one example of graphical object server 40 as operating separate from digital map server 30, in other embodiments graphical object server 40 may operate within digital map server 30. In yet other embodiments, digital map client 20, digital map server 30, and graphical object server 40 may operate within the same server. Additional details of one example of graphical object server 40 are described in more detail below.

In various embodiments of the invention, existing mapping programs, such as Google Earth, may provide a markup language to display points and lines on the digital map. A markup language refers to a language that has code that indicates layout, styling, and placement of graphics. Keyhole Markup Language (KML) is one such markup language for managing geographic data on Google Earth. A KML document may contain code describing a basic feature along with latitude and longitude coordinates of the feature. For example, a placemark, such as the location of a state capital, may be defined along with a representative icon in a KML document. However, existing mapping programs, such as Google Earth, are generally limited to displaying simple lines using the markup language, and do not natively support the display of more complicated 2D and 3D graphical objects.

According to one embodiment of the invention, a system and method are provided that display complex graphical objects on a digital map. This is effected, in one embodiment, by providing a mechanism to generate many lines of markup language code from simple metadata describing graphical objects. The markup language code is then used to render graphical objects for display on a digital map. Additional details of example embodiments of the invention are described in greater detail below in conjunction with portions of FIG. 1, FIG. 2, and FIG. 3.

According to the illustrated embodiment of the invention, graphical object server 40 includes a metadata catalog (MDC) 42 and a graphical object manager 44. In the illustrated embodiment MDC 42 resides within graphical object server 40; however, in other embodiments, MDC 42 may reside on a separate server.

MDC 42 may refer to any suitable device operable to store metadata, and facilitate addition, modification, and retrieval of such metadata. In general, metadata is data that describes other data. In the context of MDC 42, MDC 42 stores metadata as descriptive data about the graphical objects to be displayed. In accordance with a particular embodiment of the present invention, MDC 42 may utilize a relational database management system to store metadata, making metadata available and accessible through an easy to use, well understood access language, such as Structured Query Language (SQL). In other embodiments, MDC 42 may utilize other metadata management systems.

According to one embodiment, MDC 42 may locally store metadata corresponding to a graphical object type to be displayed on a digital map. A graphical object type may refer to a name of any computer data capable of being rendered on a computer in the form of an image, such as a geometric object depicted in geometric space. For example, MDC 42 may store a type value specifying a type of 3D graphic, such as an ellipsoid, to be displayed at a particular location. In other embodiments, a graphical object type may refer to a name of any digital photograph, diagram, icon, symbol, or other data capable of being rendered on a computer in the form of an image. For example, MDC 42 may store a type value specifying a type of icon, such as a military symbol, to be displayed at a particular location.

MDC 42 may locally store metadata corresponding to geographic locations of graphical objects to be displayed on a digital map, according to one embodiment of the invention. For example, MDC 42 may store a latitude, a longitude, and an altitude value describing a center point for a 3D graphic, such as an ellipsoid, to be displayed. As another example, MDC 42 may store a latitude, a longitude, and an altitude value describing a center point for a symbol, such as a military symbol, to be displayed.

According to one embodiment, MDC 42 may locally store metadata corresponding to size descriptions of graphical objects to be displayed on a digital map. For example, MDC 42 may store a width, a height, and a length value describing a size for a 3D graphic, such as an ellipsoid, to be displayed. As another example, MDC 42 may store a radius value describing a size for a 2D graphic, such as a circle, to be displayed.

Table 1 is an example document with document tags populated with properties for a graphical object that may be stored as metadata in MDC 42, in accordance with an embodiment of the present invention. A tag may refer to any marker embedded in a document that indicates data contained within an element. For example, in Table 1, line 1 the first tag indicates that the document is an Extensible Markup Language (XML) document. XML refers to a flexible syntax for describing data. Based on data type definition (DTD) files and XML Schema language files, clients, such as administrators or automated scripts, may create a document with XML tags. The self-describing XML tags map to information associated with the various graphical objects. However, other documents could equally be employed in alternative embodiments. For example, the documents may be, for example, a standard ASCII text file with some proprietary format, an HTML file, or other suitable document.

In Table 1, line 2 indicates a latitude, a longitude, and an altitude value describing a center point for a graphical object. Line 3 of Table 1 indicates a type value specifying a type of graphical object, an ellipsoid, along with a width, a height, and a length value describing a size of the ellipsoid.

TABLE 1
Sample Document

| | |
|---|---|
| 1 | <?xml version=“1.0” encoding=“UTF-8”?> |
| 2 | <render latitude=“33.30605940552157” |
| | longitude=“44.32823403459573” |
| | altitude=“0”> |
| 3 | <geo:ellipsoid width=“300” length=“300” height=“300”/> |
| 4 | </render> |

However, the present disclosure contemplates many types of graphical object properties. Various embodiments may include, some, all, or none of the enumerated properties.

Graphical object manager 44 may refer to any suitable logic embodied in computer-readable media, and when executed, that is operable to render graphical objects for display on digital map client 20. In the illustrated embodiment of the invention, graphical object manager 44 resides on graphical object server 40. In other embodiments of the invention, graphical object manager 44 may reside on digital map client 20, or any other suitable device operable to connect to MDC 42.

According to the illustrated embodiment of the invention, graphical object manager 44 includes various modules operable to perform various functions including a query module 46, a subscriber module 48, and a render module 50.

According to one embodiment of the invention, query module 46 may query MDC 42 for metadata, as indicated by reference number 41. In particular embodiments of the invention, query module 46 may query MDC 42 for any type of metadata, such as location metadata, graphical object metadata, status metadata, or any other suitable metadata. Query module 46 may query MDC 42 for metadata that match specified criteria. For example, the specified criteria used by query module 46 may include spatial criteria. Spatial criteria may specify location properties, such as latitude and longitude values, as a search filter for the graphical object metadata. As another example, the specified criteria used by query module 46 may include contextual criteria. Contextual criteria may specify patterns, such as string patterns, as a search filter for the graphical object metadata. As another example, the specified criteria used by query module 46 may include temporal criteria. Temporal criteria may specify time properties, such as a last modified date, as a search filter for the graphical object metadata. However, the present disclosure contemplates many types of query criteria. Various embodiments may include, some, all, or none of the enumerated query criteria.

Query module 46 may query MDC 42 for graphical object metadata using Java Server Pages (JSP), according to one embodiment of the invention. JSPs may utilize tags to generate a definable markup language. When executed by a JSP container, the definable markup language may generate a result in various formats, such as XML. For example, according to the runtime behavior of a JSP container, the opening element of query tag is interpreted and loaded into the system memory. Any properties specified in the tag will be loaded at runtime. Next, the JSP container interprets all nested child-tags, and the contents of their bodies are translated, and then passed back to the parent query tag. At this point, the parent query tag has the criteria it needs to query MDC 42.

According to one embodiment of the invention, search criteria, collected by query module 46, from the nested tags may be consolidated and passed to MDC 42. In other embodiments, query module 46 may query MDC 42 without search criteria. Results from MDC 42 from query module 46 loaded into a collection object. By retrieving the collection object produced by the query tag, the JSP may, at runtime, generate a developer-defined markup language document, such as the document in Table 1.

According to one embodiment of the invention, subscriber module 48 may subscribe to MDC 42 to receive continuous updates to metadata from MDC 42, as indicated by reference number 43. Subscriber module 48 may subscribe to MDC 42 for metadata that match specified criteria. For example, the specified criteria used by subscriber module 48 may include spatial criteria as described above. As another example, the specified criteria used by subscriber module 48 may include contextual criteria as described above. As another example, the specified criteria used by subscriber module 48 may include temporal criteria as described above. However, the present disclosure contemplates many types of subscription criteria. Various embodiments may include, some, all, or none of the enumerated subscription criteria.

Subscriber module 48 may subscribe to MDC 42 to receive continuous updates to metadata from MDC 42 using JSPs, according to one embodiment of the invention. For example, a user session, at digital map client 20, may be retrieved from a JSP container and a lookup may performed on a “subid” property. A “subid” property refers to a unique identifier to store and locate MDC 42 subscriber instances within the user session. If an instance is found, the subscribe process continues. If not, a new instance is generated. The instance is bound to the user's session supplied by the JSP container.

For any updates to metadata in MDC 42, subscriber module 48 may receive updates for each user session. The subscription results are loaded into a collection object. The collection object is then bound to the user session. By retrieving the collection object produced by the query tag, the JSP may, at runtime, generate a developer-defined markup language document, such as the document in Table 1.

According to one embodiment of the invention, render module 50 receives metadata and renders the metadata into a markup language for display on a digital map. For example, render module 50 may identify a graphical object type to be displayed from the received metadata. The graphical object type may be a 3D graphic, such as an ellipsoid, to be displayed on a digital map.

Render module 50 may use the received object type metadata to generate a model representing the graphical object, according to one embodiment of the invention. For example, render module 50 may generate an ellipsoid model for a particular graphical object type. To generate the model, render module 50 may input ellipsoid properties from the metadata, such as length, width, and height into an ellipsoid generating algorithm. The ellipsoid generating algorithm may generate the coordinates of the vertices of the ellipsoid model in Cartesian coordinates. As an example, and not by way of limitation, Table 2 illustrates an ellipsoid generating algorithm.

TABLE 2
Sample Algorithm for Ellipsoid

| | |
|---|---|
| 1 | raw Ellipsoid Centered at (0,0,0) { |
| 2 | resolution = props.resolution |
| 3 | length = ellipsoid.length |
| 4 | width = ellipsoid.width |
| 5 | height = ellipsoid.height |
| 6 | step = (2*PI) / resolution |
| 7 | vstep = PI / resolution |
| 8 | a = width / 2 |
| 9 | b = length / 2 |
| 10 | c = height / 2 |
| 11 | for (i = 0; i < resolution; i++) |
| 12 | for (j = 0; j < resolution; j++) |
| 13 | ang = (i * step) |
| 14 | vang = (j * vstep) |
| 15 | x = a * cos(ang ) * sin(vang) |
| 16 | y = b * sin(ang) * sin(vang) |
| 17 | z =c * cos(ang) |
| 18 | points[i][j] = (x, y, z) |
| 19 | if (i > 0 and j > 0) |
| 20 | faces[i−1][j−1]= |
| | {points[i−1][j],points[i−1][j−1],points[i][j− |
| | 1],points[i][j]} |
| 21 | for (j = 0; j <= resolution; j++) |
| 22 | if (j > 0) |
| 23 | faces[resolution−1][j−1]= |
| | {points[resolution−1][j],points[resolution−1][j−1], |
| | points[0][j−1],points[0][j]} |

According to one embodiment of the invention, render module 50 may apply rendering properties to the generated coordinates of the model. For example, the properties applied by render module 50 may include rotation and tilt properties. Rotation properties may refer to properties that rotate coordinates of a model along an axis. To apply rotation along the z-axis, render module 50 may use the following formula:

x=x.coordinate

y=(cos(rotation)*y.coordinate)+(sin(rotation)*z.coordinate)

z=(−sin(rotation)*y.coordinate)+(cos(rotation)*z.coordinate)

Tilt properties may refer to properties that tilt coordinates of a model along a North/South axis and an East/West axis. To apply tilt along the East/West axis, render module 50 may use the following formula:

x=(cos(tiltE)*x.coordinate)+(−sin(tiltE)*z.coordinate)

y=(y.coordinate)

z=(sin(tiltE)*x.coordinate)+(cos(tiltE)*z.coordinate)

To apply tilt along the North/South axis, render module 50 may use the following formula:

x=(cos(tiltN)*x.coordinate)+(sin(tiltN)*y.coordinate)

y=(−sin(tiltN)*x.coordinate)+(cos(tiltN)*y.coordinate)

z=z.coordinate

According to one embodiment of the invention, render module 50 may apply other rendering properties to the generated coordinates of the model, such as scale, altitude mode, resolution, and shadow properties. Scale properties may refer to properties that determine a size of a model. Altitude mode properties may refer to properties that determine the model's relationship to the ground. Resolution properties may refer to properties that determine a number of line segments in the model. Shadow properties may refer to properties that place a corresponding shadow element below a model. However, the present disclosure contemplates displaying many types of rendering properties. Various embodiments may include some, all, or none of the enumerated rendering properties.

According to one embodiment of the invention, render module 50 may convert the generated Cartesian coordinates of the model into a polar coordinate representation. For example, using the latitude, longitude, and altitude values passed in the metadata, the following formulas may be used by render module 50 to solve for the projected latitude and longitude polar coordinates of the model (latx/longx):

$$α = \frac{distance}{earth ' s radius at ( lat , long )}$$

$$latx = a sin ( sin ( lat ) \times cos ( α ) + cos ( heading ) \times cos ( lat ) \times sin ( α ) )$$

$$longx = long + arc tan ( \frac{sin ( heading ) \times sin ( α ) \times cos ( lat )}{cos ( α ) - sin ( lat ) \times sin ( latx )} )$$

### In the example provided, lat and long represent the center point of the model, distance represents the distance of the model point to the model center, and heading represents the angle of the model point measured from North clockwise.

With the polar coordinate representation, render module 50 may use the distance from the origin and angle to the coordinates to render the coordinates on the digital map using a markup language. A markup language document may be created based on the projected latitude (latx) and longitude (longx) coordinates of the model. For example, common markup languages include Hyper Text Markup Language (HTML) and KML. For example, a KML document may specify graphical objects for display in a digital map using KML nodes to represent the various lines and coordinates of the graphical objects.

Table 3 is an example KML document that render module 50 may generate for the graphical object of Table 1, in accordance with an embodiment of the present invention. Lines 4-12 and lines 14-22 of Table 3 indicate the polygon information that make up the portions of the 3D ellipsoid. Lines 8-9 and lines 18-19 of Table 3 indicate the coordinates of the points of the respective polygons. The ellipsis at Line 13 of Table 3 indicates that many lines of polygon data may be generated to render the 3D ellipsoid. Thus, the few lines of tags from Table 1 may generate many lines of KML content in Table 3.

TABLE 3
Sample KML Document

| | |
|---|---|
| 1 | <?xml version=“1.0” encoding=“UTF-8”?> |
| 2 | <kml xmlns=“http://earth.google.com/kml/2.0”> |
| 3 | <Placemark> |
| 4 | <MultiGeometry id=“khMultiGeometry651”> |
| 5 | <Polygon id=“khPolygon652”> |
| 6 | <altitudeMode>absolute</altitudeMode> |
| 7 | <outerBoundaryIs> |
| 8 | <LinearRing id=“khLinearRing653”> |
| 9 | <coordinates> |
| | 44.32561414514183,33.31299791749765,149.178284305241 |
| | 44.32555163679158,33.31297130128769,149.178284305241 |
| | 44.32561414514183,33.31299791749765,149.178284305241 |
| 10 | </coordinates> |
| 11 | </LinearRing> |
| 12 | </outerBoundaryIs> |
| 13 | </Polygon> |
| 14 | ... |
| 15 | <Polygon id=“khPolygon1100”> |
| 16 | <altitudeMode>absolute</altitudeMode> |
| 17 | <outerBoundaryIs> |
| 18 | <LinearRing id=“khLinearRing1101”> |
| | <coordinates> |
| | 44.32591030599476,33.31419394884433,9.184850993605149 |
| | 44.32524235027147,33.31415745737503,15.67926949014805 |
| 19 | 44.32591030599476,33.31419394884433,9.184850993605149 |
| 20 | </coordinates> |
| 21 | </LinearRing> |
| 22 | </outerBoundaryIs> |
| 23 | </Polygon> |
| 24 | </MultiGeometry> |
| 25 | </Placemark> |
| 26 | </kml> |

According to one embodiment of the invention, render module 50 may send a document, such as the sample KML document in Table 3, to digital map client 20 for display, as indicated by reference number 23. For example, digital map client 20 may communicate to graphical object server 40 a particular location currently displayed to a user, as indicated by reference number 21. Render module 50 may receive a document, such as the document in FIG. 1, for a graphical object to be displayed at the particular location. Render module 50 may render the document into a markup language document, such as KML, and pass the markup language document to digital map client 20 to display the graphical object at the particular location.

FIG. 2 is a representative image 110 illustrating graphical objects on a digital map in accordance with an embodiment of the present invention. As shown in FIG. 2, image 110 generally includes a 2D circle object 120, a 3D sphere object 122, a 3D cone object 124, a 2D ring object 126, a 3D cylinder object 128, a 3D box object 130, and a 3D hemisphere object 132. However, the present disclosure contemplates displaying many types of graphical objects. Various embodiments may include some, all, or none of the enumerated graphical objects.

According to one embodiment of the invention, image 110 may be generated by using a markup language document, such as KML, to draw graphic objects with wire frame and triangular mesh lines of 2D and 3D objects. The coordinates of the lines defining the objects may have latitude, longitude, and altitude values stored in the respective KML documents. The coordinates may be generated from metadata describing the graphical objects in terms of type, size, and location.

Image 110 may be generated by retrieving a base map image for a specified location. The specified location may be used to query a metadata catalog for graphical objects at the specified location. Next, a model of each graphical object at the specified location may be generated with Cartesian coordinates. The Cartesian coordinates may be converted into polar coordinates for projection onto a digital map. A markup language document, such as a KML document, may be generated based on the converted coordinates. The KML document is used by a digital map client to render the graphical objects at the specified location. According to various embodiments, a few lines of graphical object properties may generate thousands of lines of KML code, depending on the complexity of the graphical object to be displayed. This approach significantly reduces development time and software maintenance cost to generate similar results.

FIG. 3 is a flow chart illustrating example acts associated with a method for displaying graphical objects on a digital map. The example acts may be performed by graphical object manager 44, as discussed above with reference to FIG. 1. At step 302, graphical object metadata may be received. In particular embodiments of the invention, the received metadata may include a graphical object type to be displayed on a digital map. For example, the metadata catalog may store a type value specifying an ellipsoid, to be displayed at a given location. In particular embodiments of the invention, the received metadata may include geographic locations of graphical objects to be displayed at a particular location. For example, the metadata catalog may store a latitude, a longitude, and an altitude value describing a center point for a 3D graphic, such as an ellipsoid, to be displayed. In particular embodiments of the invention, the received metadata may include size descriptions of graphical objects to be displayed on a digital map. For example, the metadata catalog may store a width, a height, and a length value describing a size for a 3D graphic, such as an ellipsoid, to be displayed.

At step 304, a model is generated based on the received metadata. The type of the graphical object may determine the algorithm used to generate the model. For example, an ellipsoid model may be generated for a particular graphical object type. To generate the model, ellipsoid properties from the metadata, such as length, width, and height may be applied to an ellipsoid generating algorithm. The ellipsoid generating algorithm may generate the coordinates of the ellipsoid model in Cartesian coordinates.

At step 306, the coordinates of the model are converted to project the coordinates on a digital map. In particular embodiments of the invention, the generated Cartesian coordinates of the model may be converted into a polar coordinate representation. For example, using the latitude, longitude, and altitude values in the metadata, conversion formulas may be used to solve for the projected latitude and longitude polar coordinates of the model.

At step 308, the graphical object may be rendered based on the converted coordinates. For example, with the polar coordinate representation, the distance from the origin and angle to the coordinates may be used to project the coordinates on the digital map. A markup language document may be created based on the projected latitude (latx) and longitude (longx) coordinates. For example, common markup languages include HTML and KML.

Thus, by providing size, center location, and type metadata for a graphical object, geographic coordinates may be generated in order to display the graphical object on a digital map. For example, a KML document may be used to define the graphical object using KML nodes to associate the various lines and geographic coordinates representing the graphical object.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method for displaying graphical objects on a digital map, comprising:
receiving, for a graphical object, metadata comprising a parameter indicative of a type of the graphical object, a plurality of parameters indicative of a size of the graphical object, and a plurality of parameters indicative of a geographic location of the object represented by the graphical object, the type being one of a plurality of stored types; and
rendering the graphical object on the digital map by generating, based the received metadata, a plurality of geographic coordinates for the graphical object.

2. The method of claim 1, wherein rendering the graphical object on the digital map by generating, based the received metadata, a plurality of geographic coordinates for the graphical object comprises:
generating a model representing the graphical object, the model comprising a plurality of Cartesian coordinates; and
generating a plurality of polar coordinates by converting the plurality of Cartesian coordinates.

3. The method of claim 1, wherein rendering the graphical object on the digital map comprises an act selected from the group consisting of:
rendering a 3D graphic;
rendering a 2D graphic; and
rendering an icon.

4. The method of claim 1, wherein the plurality of parameters indicative of a geographic location of the object represented by the graphical object comprises a parameter indicative of a longitude of the graphical object, a parameter indicative of a latitude of the graphical object, and a parameter indicative of an altitude of the graphical object.

5. The method of claim 1, further comprising applying a plurality of rendering properties to the graphical object, wherein the plurality of rendering properties comprises one or more tilt properties.

6. The method of claim 1, further comprising subscribing to a metadata catalog to receive updates to the received metadata.

7. The method of claim 1, wherein rendering the graphical object on the digital map comprises generating a Keyhole Markup Language (KML) document based on the converted coordinates.

8. A system for displaying graphical objects on a digital map comprising:
a digital map client operable to operable to display the digital map;
a digital map server to store the digital map and operable to deliver the digital map to the digital map client; and
a graphical object manager coupled to the digital map client and operable to:
receive, for a graphical object, metadata comprising a parameter indicative of a type of the graphical object, a plurality of parameters indicative of a size of the graphical object, and a plurality of parameters indicative of a geographic location of the object represented by the graphical object, the type being one of a plurality of stored types; and
render the graphical object on the digital map by generating, based the received metadata, a plurality of geographic coordinates for the graphical object.

9. The system of claim 8, wherein the graphical object manager is further operable to:
generate a model representing the graphical object, the model comprising a plurality of Cartesian coordinates; and
generate a plurality of polar coordinates by converting the plurality of Cartesian coordinates.

10. The system of claim 8, wherein the graphical object manager is further operable to render the graphical object on the digital map by an act selected from the group consisting of:
rendering a 3D graphic;
rendering a 2D graphic; and
rendering an icon.

11. The system of claim 8, wherein the plurality of parameters indicative of a geographic location of the object represented by the graphical object comprises a parameter indicative of a longitude of the graphical object, a parameter indicative of a latitude of the graphical object, and a parameter indicative of an altitude of the graphical object.

12. The system of claim 8, wherein the graphical object manager is further operable to apply a plurality of rendering properties to the graphical object, wherein the plurality of rendering properties comprises one or more tilt properties.

13. The system of claim 8, wherein the graphical object manager is further operable to subscribe to a metadata catalog to receive updates to the received metadata.

14. The system of claim 8, wherein the graphical object manager is operable to render the graphical object on the digital map by generating a Keyhole Markup Language (KML) document based on the converted coordinates.

15. Logic encoded in computer-readable media, the logic being operable, when executed, to:
receive, for a graphical object, metadata comprising a parameter indicative of a type of the graphical object, a plurality of parameters indicative of a size of the graphical object, and a plurality of parameters indicative of a geographic location of the object represented by the graphical object, the type being one of a plurality of stored types; and
render the graphical object on the digital map by generating, based the received metadata, a plurality of geographic coordinates for the graphical object.

16. The logic of claim 15, wherein the logic is further operable to:
generate a model representing the graphical object, the model comprising a plurality of Cartesian coordinates; and
generate a plurality of polar coordinates by converting the plurality of Cartesian coordinates.

17. The logic of claim 15, wherein the logic is further operable to render the graphical object on the digital map by an act selected from the group consisting of:
rendering a 3D graphic;
rendering a 2D graphic; and
rendering an icon.

18. The logic of claim 15, wherein the plurality of parameters indicative of a geographic location of the object represented by the graphical object comprises a parameter indicative of a longitude of the graphical object, a parameter indicative of a latitude of the graphical object, and a parameter indicative of an altitude of the graphical object.

19. The logic of claim 15, wherein the logic is further operable to apply a plurality of rendering properties to the graphical object, wherein the plurality of rendering properties comprises one or more tilt properties.

20. The logic of claim 15, wherein the logic is operable to render the graphical object on the digital map by generating a Keyhole Markup Language (KML) document based on the converted coordinates.
